(19) United States
(12) Patent Application Publication
(10) Pub. No.: US 2026/0332196 A1
(43) Pub. Date: Oct. 22, 2026

(54) FACILITATING FOUR TRANSCEIVER CROSS-POLARIZED ANTENNA CELL WIDE BEAM POWER TRANSMISSION IN ADVANCED NETWORKS

(71) Applicant: Dell Products L.P., Round Rock, TX (US)

(72) Inventors: Youqian Xiao, Toronto (CA); Ravi Sharma, Cupertino, CA (US); Eran Goldstein, Montreal (CA); Vikas Arora, Ottawa (CA)

(21) Appl. No.: 19/186,299

(22) Filed: Apr. 22, 2025

(51) Int. Cl. H04B 7/0456; H01Q 21/06; H01Q 25/00

(52) U.S. Cl. CPC H04B 7/0456; H01Q 21/06; H01Q 25/001

(57) ABSTRACT

The subject technologies relate to facilitating four transceiver cross-polarized antenna cell wide beam power transmission in advanced networks. A method includes generating, by a system comprising at least one processor, precoded data for transmission, via multiple transmit antenna elements, using a precoding matrix corresponding to different transmission layers. The method also includes transmitting, by the system via the multiple transmit antenna elements, the precoded data to a user equipment. Further, a first transmission phase difference between a first antenna element and a second antenna element of the multiple transmit antenna elements comprises a first polarization. A second transmission phase difference between a third antenna element and a fourth antenna element of the multiple transmit antenna elements comprises a second polarization. A transmission phase difference between the first polarization and the second polarization is a 180 degree phase difference or about a 180 degree phase difference.

### BACKGROUND

Four-transceiver (4TRX) is a cell configuration for both Long Term Evolution (LTE) and New Radio (NR) macro-sites. The 4TRX site uses one 4-port or two 2-port cross-polarized (x-pol) antennas. From such a 4TRX site, how to transmit cell level channels, such as single-sideband (SSB) or physical downlink control channel (PDCCH) is vendor dependent, and is not defined in the Third Generation Partnership Project (3GPP) specification.

The above-described context with respect to wide beam power emission patterns is merely intended to provide an overview of current technology and is not intended to be exhaustive. Other contextual descriptions, and corresponding benefits of some of the various non-limiting embodiments described herein, will become further apparent upon review of the following detailed description.

### SUMMARY

The following presents a simplified summary of the disclosed subject matter to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An embodiment relates to a method that includes generating, by a system comprising at least one processor, precoded data for transmission, via multiple transmit antenna elements, using a precoding matrix corresponding to different transmission layers. The method also includes transmitting, by the system via the multiple transmit antenna elements, the precoded data to a user equipment. Further, a first transmission phase difference between a first antenna element and a second antenna element of the multiple transmit antenna elements comprises a first polarization. A second transmission phase difference between a third antenna element and a fourth antenna element of the multiple transmit antenna elements comprises a second polarization. A transmission phase difference between the first polarization and the second polarization is a 180 degree phase difference or about a 180 degree phase difference.

According to an implementation, the precoding matrix comprises a group of weight factors comprising a first weight factor, a second weight factor, a third weight factor, and a fourth weight factor. Further to this implementation, the method includes assigning, by the system, a first value to the first weight factor, the second weight factor, and the third weight factor. The method also includes assigning, by the system, a second value to the fourth weight factor. In an example, the first value is a positive value, and the second value is a negative value. In another example, the first value is 1, and the second value is −1. In yet another example, the first value is −1, and the second value is 1.

In accordance with an implementation, the first antenna element, the second antenna element, the third antenna element, and the fourth antenna element are located in a same radome. According to another implementation, the first antenna element and the second antenna element are located in a first radome. Further to this implementation, the third antenna element and the fourth antenna element are located in a second radome, different than the first radome.

Another embodiment relates to network equipment that includes a transmission device comprising a four-transceiver cell configuration. The transmission device includes a first antenna pair and a second antenna pair. The first antenna includes a first antenna and a second antenna. The second antenna pair includes a third antenna and a fourth antenna. The network equipment also includes a precoder that generates precoded data using a precoding matrix that comprises a first signal phase assigned to the first antenna, a second signal phase assigned to the second antenna, a third signal phase assigned to the third antenna, and a fourth signal phase assigned to the fourth antenna. The fourth signal phase is a 180 degree signal phase difference from the first signal phase, the second signal phase, and the third signal phase. In addition, the network equipment includes a transmitter that transmits the precoded data according to the precoding matrix.

In an implementation, the first signal phase is zero degrees, the second signal phase is α degrees, the third signal phase is β degrees, and the fourth signal phase is of β plus α and around 180 degrees. In some implementations, a group of weight factors assigned to the precoder comprises 1, 1, 1, and −1, or any combination thereof. According to some implementations, a group of weight factors assigned to the precoder comprises −1, −1, −1, and 1, or any combination thereof.

In an example, the first antenna pair and the second antenna pair are located in a same structural enclosure. In another example, the first antenna pair is located in a first structural enclosure, and the second antenna pair is located in a second structural enclosure different than the first structural enclosure.

According to some implementations, an overall power emission pattern of the transmitter is omnidirectional. In some implementations, the transmitter conveys cell level signals with a full power capacity assigned to the transmission device. In accordance with some implementations, the transmitter conveys data, via data channels, with a full power capacity assigned to the transmission device.

Yet another embodiment relates to a non-transitory machine-readable medium, comprising executable instructions that, when executed by at least one processor of network equipment, facilitate performance of operations. The operations can include generating precoded data for transmission, via multiple transmit antenna elements, using a precoding matrix corresponding to different transmission layers. A first transmission phase difference between a first antenna element and a second antenna element of the multiple transmit antenna elements comprises a first polarization. A second transmission phase difference between a third antenna element and a fourth antenna element of the multiple transmit antenna elements comprises a second polarization. Further, a transmission phase difference between the first polarization and the second polarization is a 180 degree phase difference or substantially a 180 degree phase difference. The operations can also include transmitting, via the multiple transmit antenna elements, the precoded data to a user equipment. In an example, transmitting comprises conveying cell level signals with a full power capacity assigned to the network equipment.

According to some implementations, the precoding matrix comprises a group of weight factors comprising a first weight factor, a second weight factor, a third weight factor, and a fourth weight factor. Further to these implementations, the operations include assigning a first value to the first weight factor, the second weight factor, and the third weight factor. The operations also include assigning a second value to the fourth weight factor. Further to these implementations, the first value is 1, and the second value is −1.

To the accomplishment of the foregoing and related ends, the disclosed subject matter includes one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description can include additional or alternative embodiments beyond those described in this summary.

### BRIEF DESCRIPTION OF THE DRAWINGS

Various non-limiting embodiments are further described with reference to the accompanying drawings in which:

FIG. 1 illustrates an example, four transceiver (4Tx) cross-polarized antenna configuration in accordance with one or more embodiments described herein;

FIG. 2 illustrates a schematic representation of beamforming of two antennas in accordance with one or more embodiments described herein;

FIG. 3 illustrates a beam pattern of two antennas with λ/2 distance in accordance with one or more embodiments described herein;

FIG. 4 illustrates a beam pattern of two antennas with 1λ distance in accordance with one or more embodiments described herein;

FIG. 5 illustrates an example, non-limiting, 4T port cross-polarized power emission pattern in accordance with one or more embodiments described herein;

FIG. 6 illustrates an example, non-limiting, system that facilitates four transceiver cross-polarized antenna cell wide beam power transmission in advanced networks in accordance with one or more embodiments described herein;

FIG. 7 illustrates a schematic representation of a distance between antenna element pairs in accordance with one or more embodiments described herein;

FIG. 8 illustrates an example, non-limiting, computer-implemented method that facilitates four transceiver cross-polarized antenna cell wide beam power transmission in advanced networks in accordance with one or more embodiments described herein;

FIG. 9 illustrates an example, non-limiting, computing environment in which one or more embodiments described herein can be facilitated;

FIG. 10 illustrates an example, non-limiting, networking environment in which one or more embodiments described herein can be facilitated;

FIG. 11 illustrates a first equation (1) for a phase difference between two antenna elements on the same polarization that is 180 degrees different to the phase difference of the other two antennas on the other polarization in accordance with one or more embodiments described herein;

FIG. 12 illustrates a second equation (2) for the composite signal on the air if the same signal s(t) is transmitted on two antennas, on the azimuth direction θ (the angle to the boresight direction) in accordance with one or more embodiments described herein;

FIG. 13 illustrates a third equation (3) for the composite signal power if the power of each signal is 1 in accordance with one or more embodiments described herein;

FIG. 14 illustrates a fourth equation (4) for signals that are transmitted onto the four antennas with different phase shifts in accordance with one or more embodiments described herein;

FIG. 15 illustrates a fifth equation (5) for calculating signals from antenna 0 and antenna 1 on the +45 degree polarization in accordance with one or more embodiments described herein;

FIG. 16 illustrates a sixth equation (6) for the normalized power of a composite signal in accordance with one or more embodiments described herein;

FIG. 17 illustrates a seventh equation (7) for calculating signals from antenna 0 and antenna 1 on the −45 degree polarization in accordance with one or more embodiments described herein;

FIG. 18 illustrates an eighth equation (8) for the total emission power of both polarization directions in accordance with one or more embodiments described herein;

FIG. 19 illustrates a ninth equation (9) for a result of the eighth equation (8) given defined terms in accordance with one or more embodiments described herein;

FIG. 20 illustrates a tenth equation (10) for two conditions in accordance with one or more embodiments described herein; and

FIG. 21 illustrates an example, non-limiting, eleventh equation (11) for use of a precoder in accordance with one or more embodiments described herein.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details. In other instances, well-known structures and devices are shown in block diagram form in order to facilitate describing the various embodiments.

As mentioned above, four-transceiver (4TRX) is a cell configuration for both Long Term Evolution (LTE) and New Radio (NR) macro-site. 4TRX uses one 4-port or two 2-port cross-polarized (x-pol) antennas. From such a 4TRX site, how to transmit cell level channels, such as single-sideband (SSB) or physical downlink control channel (PDCCH) is vendor dependent, and is not defined in the Third Generation Partnership Project (3GPP) specification.

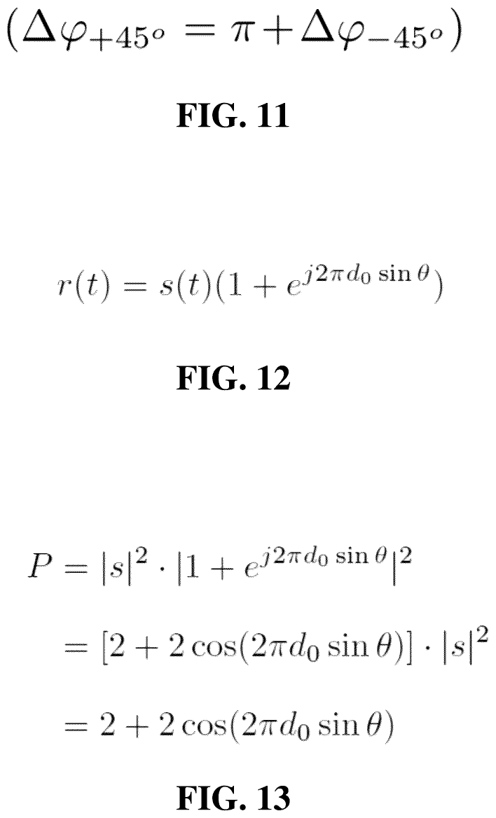

Provided herein is a precoding design principle to produce an omnidirectional power emission pattern out of the 4T x-pol configuration. As discussed herein, for a x-pol 4TX antenna, an effective omnidirectional power emission pattern can be achieved by shifting the signal phases on the four TX ports in a certain way. As also provided herein, when a phase difference between two antenna elements on the same polarization is 180 degrees different to the phase difference of the other two antennas on the other polarization, as indicated by first equation (1) below (and depicted in FIG. 11),

$$( {Δ}_{φ + {45}^{0}} = π + {Δ}_{φ - {45}^{0}} ) , \qquad Equation ( 1 )$$

the overall power emission pattern, consisting of both polarizations, will be omnidirectional.

For example, the overall power emission pattern is the same on all horizontal directions, regardless of the distance between the two columns of antennas. As will be discussed in further detail below, a precoder for this purpose is, for example, [1, 1, 1, −1]. This can be especially useful for common channel or common signal precoding, in order to both utilize all the power resources and at the same time maintain the cell level wide-beam.

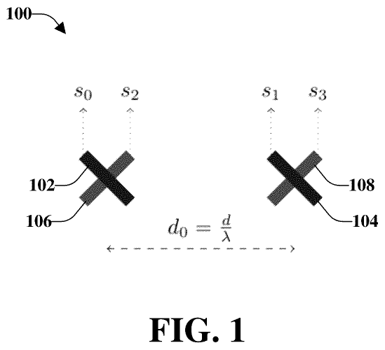

FIG. 1 illustrates an example, 4Tx cross-polarized antenna configuration 100 in accordance with one or more embodiments described herein. The configuration 100 includes four antenna elements, depicted as a first antenna 102, a second antenna 104, a third antenna 106, and a fourth antenna 108. Each antenna element is powered by a separate power amplifier (PA). For example, the first antenna 102 is powered by a first power amplifier, the second antenna 104 is powered by a second power amplifier, the third antenna 106 is powered by a third power amplifier, and the fourth antenna 108 is powered by a fourth power amplifier. As illustrated, the first antenna 102 outputs a first signal s₀, the second antenna 104 outputs a second signal s₁, the third antenna 106 outputs a third signal s₂, and the fourth antenna 108 outputs a fourth signal s₃.

A distance d between the two columns of x-pol antennas can be defined as

$${d}_{0} = \frac{d}{λ} .$$

In some implementations, the two columns of x-pol antennas (e.g., first column includes the first antenna 102 and the third antenna 106; a second column includes the second antenna 104 and the fourth antenna 108) can be integrated inside the same radome, which is a structural and weatherproof protective enclosure that is used to protect an antenna. Since the two columns of x-pol antennas are integrated inside the same radome, they are very close to each other, typically targeting for beamforming gain. However, according to some implementations, the two columns of x-pol antennas can also be located in two separated antenna radomes and be installed widely separated, targeting for space multiplexing gain or diversity gain.

In both LTE and NR all those 4Tx are used for data channel transmission, with user equipment (UE) specific precoding to constructively align signals from the four ports. However for common channels, such as SSB or PDCCH (CORESET0), since there may be no UE specific precoding information available, it may not be able to align those signals correctly. To avoid the possible destructive signal alignment, conventional methods only transmit common signals on one antenna, with the cost of only one fourth (¼) of the total power being used.

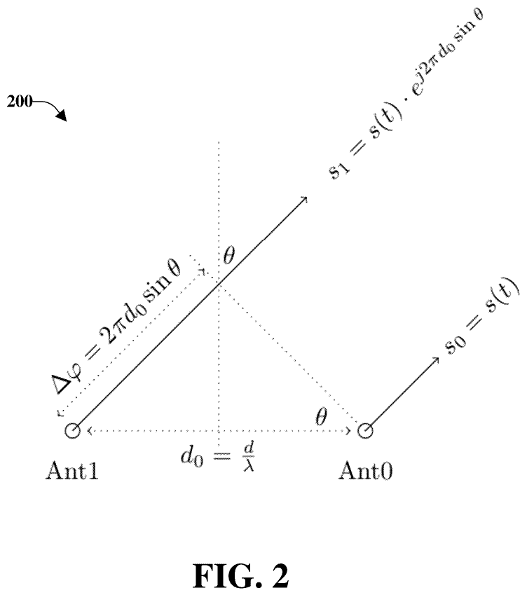

To understand the challenge, the following explains the situation where two Tx co-polarized antenna are transmitting, as shown in FIG. 2, which illustrates a schematic representation 200 of beamforming of two antennas in accordance with one or more embodiments described herein. The schematic representation 200 depicts the beamforming of a first antenna Ant0 and a second antenna Ant1. If the same signal s(t) is transmitted on these two antennas, on the azimuth direction θ (the angle to the boresight direction), the composite signal on the air would be as indicated in second equation (2) below (and also depicted in FIG. 12):

$$r ( t ) = s ( t ) ( 1 + {e}^{j 2 π {d}_{0} sin θ} ) \qquad Equation ( 2 )$$

If the power of each signal is 1, then the power of the composite signal would be as indicated in third equation (3) below (and also depicted in FIG. 13).

$$P = {\vert s \vert}^{2} . \vert {e}^{j 2 π {d}_{0} sin θ} \vert = [ 2 + 2 cos ( 2 π {d}_{o} sin θ ) ] . {\vert s \vert}^{2} 2 + 2 cos ( 2 π {d}_{0} sin θ ) . \qquad Equation ( 3 )$$

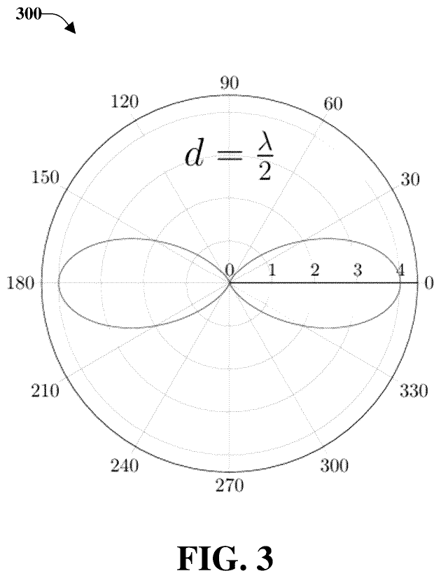

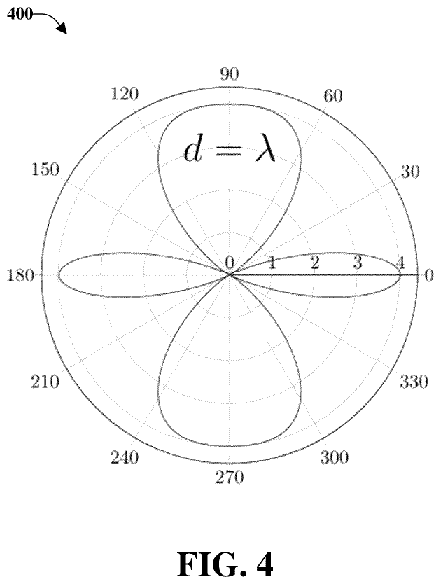

FIGS. 3 and 4 illustrate emission patterns for d=λ/2 and d=λ, respectively. More specifically, FIG. 3 illustrates a beam pattern of two antennas with λ/2 distance in accordance with one or more embodiments described herein. Additionally, FIG. 4 illustrates a beam pattern of two antennas with 1λ distance in accordance with one or more embodiments described herein. As illustrated in FIG. 4, if a UE is located in an area, such as around 30° or 330° (or 2100 or 150°) in this example, there will be no power, with no energy going to that UE.

From the above analysis, it can be determined that, when transmitting the same signals from two co-polarized antennas, the effective emission pattern will not be “omni” anymore. Instead, the effective emission pattern will become directional. For example, the effective emission pattern will be enhanced on some direction and suppressed on another direction.

Due to this phenomenon, when working with 4Tx antenna, with two antennas on +45° polarization and the other two on −45° polarization, directly duplicate signals onto all the antennas is not possible as the resulted directional pattern could cause erratic coverage. This is a reason why conventional methods would rather transmit only on one antenna using one PA, and give up three-quarters (¾) of the total power capability by not using the other three antennas and the other three PAs.

Effective Omni-Pattern: When signals are transmitted on the two orthogonal polarization respectively, the signals will not affect each other. That is to say that there is no “beamforming” effect between the signals. As discussed herein, this property is used to generate and combine two complementary patterns on each polarization, and form an omnidirectional power emission pattern.

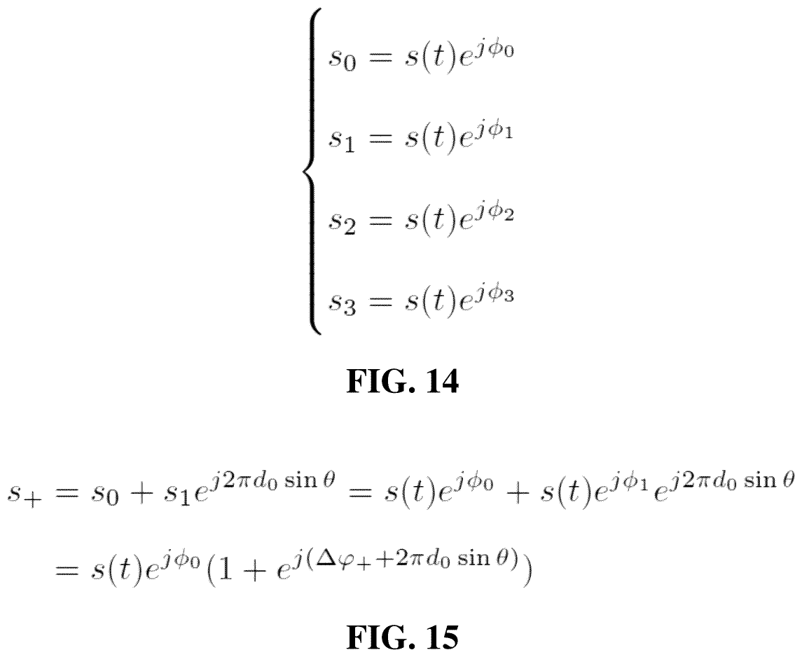

By way of example and with reference again to FIG. 1, signals are transmitted onto the four antennas with different phase shifts as noted in fourth equation (4) below (and depicted in FIG. 14):

$$\{ \begin{matrix}{s}_{0} = s ( t ) {e}^{j {∅}_{0}} \\ {s}_{1} = s ( t ) {e}^{j {∅}_{1}} \\ {s}_{2} = s ( t ) {e}^{j {∅}_{2}} \\ {s}_{3} = s ( t ) {e}^{j {∅}_{3}}\end{matrix} . \qquad Equation ( 4 )$$

where s₀ is a first phase, s₁ is a second phase, s₂ is a third phase and s₃ is a fourth phase.

On the +45 degree polarization, signals from antenna 0 and antenna 1 will be determined (e.g., calculated or added up) as indicated by fifth equation (5) below (also depicted in FIG. 15):

$${s}_{+} = {s}_{0} + {s}_{1} {e}^{j 2 π {d}_{0} sin θ} = s ( t ) {e}^{j {∅}_{0}} + s ( t ) {e}^{j {∅}_{1}} {e}^{j 2 π {d}_{0} sin θ} = s ( t ) {e}^{j {∅}_{0}} ( 1 + {e}^{j ( Δφ + 2 π {d}_{0} sin θ )} ) . \qquad Equation ( 5 )$$

where, Δφ₊=φ₁−φ₀, is the phase shift difference between antenna 0 and antenna 1, and 0 is the azimuth direction of emission.

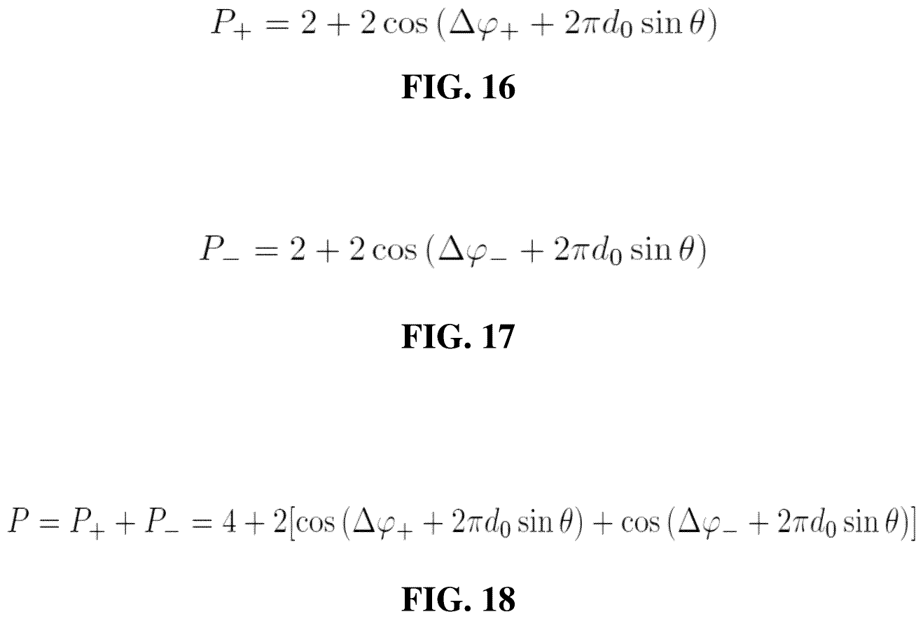

Thus, the normalized power of composite signal is (normalize by power of s(t)), as indicated in sixth equation (6) below (and depicted in FIG. 16).

$${P}_{+} = 2 + 2 cos ( {Δ}_{φ +} + 2 π {d}_{0} sin θ ) . \qquad Equation ( 6 )$$

On the −45 degree polarization, signals are calculated (e.g., added up) in a similar manner, as indicated in seventh equation (7) below (and depicted in FIG. 17).

$${P}_{-} = 2 + 2 cos ( {Δ}_{φ -} + 2 π {d}_{0} sin θ ) . \qquad Equation ( 7 )$$

where, Δ_{φ}=Ø₃−Ø₂ is the phase difference between s₃ and s₂.

The total emission power of both polarization directions are indicated in eighth equation (8) below (and also depicted in FIG. 18).

$$P = {P}_{+} + {P}_{-} = 4 + 2 [ cos ( {Δ}_{φ +} + 2 π {d}_{0} sin θ ) + cos ( {Δ}_{φ -} + 2 π {d}_{0} sin θ ) ] . \qquad Equation ( 8 )$$

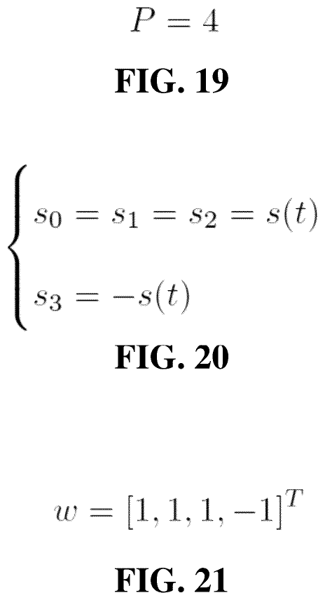

By letting: Δ_{φ+}=π+Δ_{φ-}, it will cancel out all terms about θ, and d₀, and the result is as per ninth equation (9) below (and also depicted in FIG. 19):

$$P = 4 . \qquad Equation ( 9 )$$

which is constant for any horizontal emission direction θ. That is, it is an effectively omnidirectional power emission pattern. It is also noted that it is also constant for any distance d₀.

Therefore, based on at least the above discussion, it has been proven that an effective omnidirectional power emission pattern can be made out of 4Tx X-Pol antenna, by adding a 180 degree more phase shift difference (or around a 180 degree more phase shift difference) on one of the other polarizations.

The following will discuss a manner to achieve the disclosed embodiments. Let the following two conditions as per tenth equation (10) below (also depicted in FIG. 20) be true:

$$\{ \begin{matrix}{s}_{0} = {s}_{1} = {s}_{2} = s ( t ) \\ {s}_{3} = - s ( t )\end{matrix} . \qquad Equation ( 10 )$$

To use the precoder, the following is an example, non-limiting, eleventh equation (11) that can be used (also depicted in FIG. 21):

$$w = {[ 1 , 1 , 1 , - 1 ]}^{T} . \qquad Equation ( 11 )$$

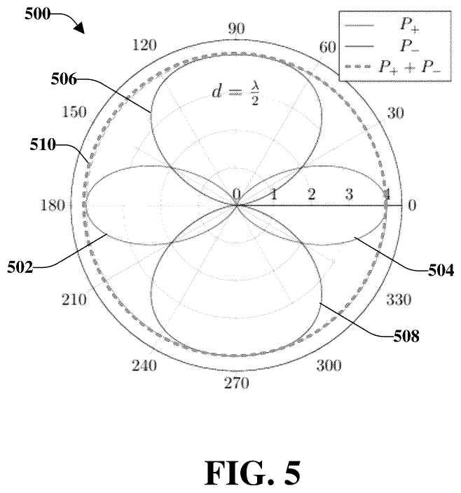

FIG. 5 illustrates an example, non-limiting, 4T x-pol power emission pattern in accordance with one or more embodiments described herein. More specifically, FIG. 5 illustrates the power patterns on each polarization and the overall pattern. The emission patterns denoted by 502 and 504 is for P₊ (P positive). The emission patterns denoted by 506 and 508 are for P₋ (P negative). The emission pattern denoted 510 (large circle) is for P₊+P₋ (P positive plus P negative).

It is noted that FIG. 5 assumes antenna with λ/2 distance. However, since both d and θ are canceled out from the formula, this method can be utilized for any dual x-pol antenna configurations, regardless of the distance between the antenna columns.

As discussed herein, a virtually omnidirectional power emission antenna can be achieved out of 4T x-Pol antenna, by adding a 180 degree extra phase shift difference (or around a 180 degree extra phase shift difference) on another polarization. A way to do this is to use the precoder as per Equation 11 above, namely:

$$w = {[ 1 , 1 , 1 , - 1 ]}^{T} . \qquad Equation 11$$

The precoder has no requirement of antenna cable connections. That is to say, the radio unit (RU) ports and the antenna ports can be connected in any manner, or the extra about 180 degree phase could be added on any branch, as long as the cable lengths are the same, the composite power emission pattern will be omnidirectional. It is noted that the precoder [1, 1, 1, −1]^{T} is not part of 3GPP NR downlink codebook. Further, the disclosed embodiments work for 4T x-pol configuration.

With reference again to FIG. 3 and FIG. 4, cellular cell level signals and channels usually need to be transmitted on cell wide beam. When multiple antennas are used, it becomes challenging on how to transmit the cell level signals and common channels. If two co-polarized omni-directional antennas transmit the same signal, the resulted electromagnetic wave on air becomes directional.

The shape and direction of the resulted beam varies for different antenna distances [see example, with ½ or 1 wavelength distance], as well as signal phase difference. A conventional process is to transmit those signals and common channels only on one antenna. Since each antenna is driven by a separate PA and use only one antenna, this means in the conventional process only one of the PA is actually used. Accordingly, the power capabilities of the other PAs is not used and, therefore, such potential power capacity is wasted.

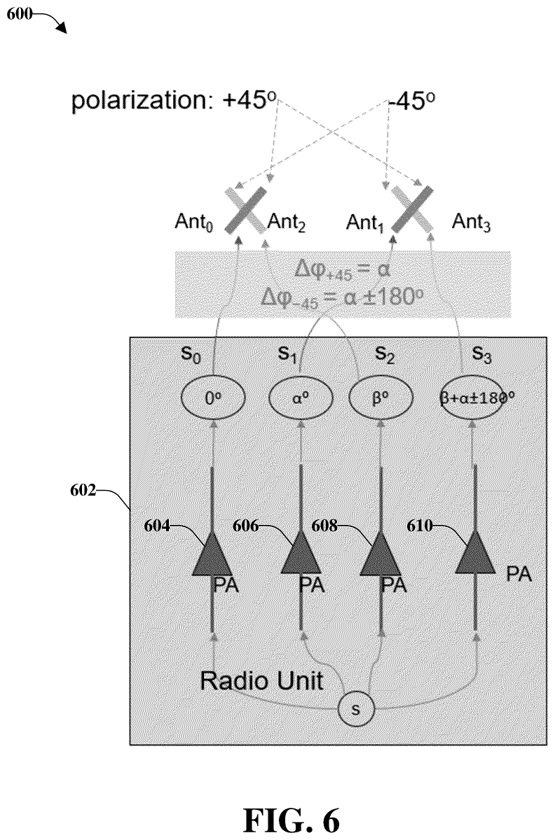

FIG. 6 illustrates an example, non-limiting, system 600 that facilitates four transceiver cross-polarized antenna cell wide beam power transmission in advanced networks in accordance with one or more embodiments described herein. The system 600 includes a radio unit 602 that comprises four Power Amplifiers (PAs), illustrated as a first PA 604, a second PA 606, a third PA 608, and a fourth PA 610.

A signal s is transmitted through each PA and output at a defined transmission phase. In the example of FIG. 6, the output of the first PA 604 is conveyed with a transmission phase of zero degrees (0°), and identified as a first signal S₀. The output of the second PA 606 is conveyed with a transmission phase of α degrees (α°) and identified as a second signal S₁. Further, the output of the third PA 608 is conveyed with a transmission phase of β degrees (β°) and identified as a third signal S₂. In addition, the output of the fourth PA 610 is conveyed with a transmission phase of β plus α and around 180 degrees (β+α±180°) and identified as a third signal S₃.

The first signal S₀ is output on a first antenna Ant₀. The second signal S₁ is output on a second antenna Ant₁. The third signal S₂ is output on a third antenna Ant₂. Further, the fourth signal S₃ is output on a fourth antenna Ant₃. As indicated, the polarization of the first antenna Ant₀ and the second antenna Ant₁ is 45 degrees (45°). Further, the polarization of the third antenna Ant₂ and the fourth antenna Ant₃ is negative 45 degrees (−45°). It is noted that the transmission of the signals can be facilitated via at least one precoder (not shown) and at least one transmission device (not shown).

Accordingly, the system 600 has a design principle to produce a wide beam power emission pattern out of the 4TX cross-polarized (X-pol) antenna configuration. For X-pol 4TX antenna, the effective omnidirectional power emission pattern can be achieved by shifting the signal phases on the four TX ports in a certain way.

When the phase difference between two antenna elements on the same polarization is 180° different to the phase difference of the other two antennas on the other polarization (Δφ₊₄₅=Δφ₋₄₅±180°), the overall power emission pattern, including both polarizations, is omnidirectional. That is to say, the overall power emission pattern is the same on all horizontal directions, no matter how much the distance between the two columns of antennas is.

One simple and straight-forward group of weight factors for this purpose is [1, 1, 1, −1], or any combination thereof. For example, additional combinations can include, but are not limited to any combination the includes three ones and one negative one. Such as, for example, [1, 1, −1, 1], [1, −1, 1, 1], [−1, 1, 1, 1].

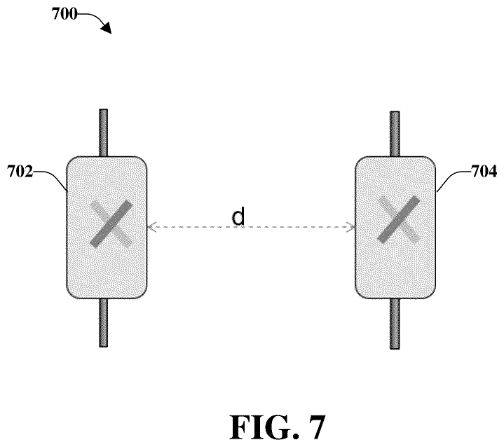

FIG. 7 illustrates a schematic representation of a distance between antenna element pairs in accordance with one or more embodiments described herein. Repetitive description of like elements employed in other embodiments described herein is omitted for sake of brevity.

Illustrated are a first column of x-pol antennas 702 and a second column of x-pol antennas 704. The first column of x-pol antennas 702 can include, for example, the first antenna Ant₀ and the third antenna Ant₂. The second column of x-pol antennas 702 can include, for example, the second antenna Ant₁ and the fourth antenna Ant₃.

A distance d between the two columns of x-pol antennas (e.g., the first column of x-pol antennas 702 and the second column of x-pol antennas 704) can be defined as

$${d}_{0} = \frac{d}{λ} .$$

In some implementations, the two columns of x-pol antennas can be integrated inside the same enclosure or radome. Since the two columns of x-pol antennas are integrated inside the same radome, they are very close to each other, typically targeting for beamforming gain. However, according to some implementations, the two columns of x-pol antennas can also be located in two separated antenna radomes and be installed widely separated, targeting for space multiplexing gain or diversity gain.

An advantage of the disclosed embodiments is to enable 4 X-pol antenna-based cell be able to transmits cell level signals or channels with full power capacity. Another advantage is that cell coverage and performance can be improved. A further advantage is that the principle of the disclosed embodiments is applicable for any antenna form, or installation distance (if with two separate radomes) or manufacturing spec (within one radome). Yet another advantage is that the simple weight factors of any combination of three “1”s and another “−1” means the design has no pre-requisite of antenna port connections and can tolerate potential antenna cross-connections errors.

It is noted that the disclosed embodiments are equally valid to any directional antennas. Further, when the disclosed embodiments are on directional antennas, the resulted power emission pattern is the product of the effective omni-pattern and the antennas directional pattern. In addition, in addition to the described weight factors, the principle of 180° phase difference could be used for any other complex 4TX codebook design.

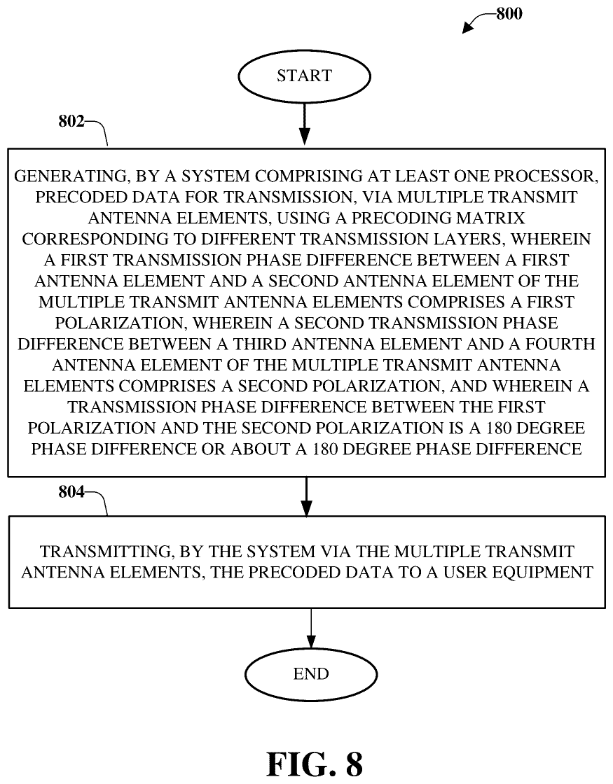

FIG. 8 illustrates an example, non-limiting, computer-implemented method 800 that facilitates four transceiver cross-polarized antenna cell wide beam power transmission in advanced networks in accordance with one or more embodiments described herein. The computer-implemented method 800 and/or other methods discussed herein can be implemented by network equipment comprising a processor. According to another example, the computer-implemented method can be implemented by a system (e.g., the system 600) comprising at least one processor and a memory.

The computer-implemented method 800 starts at 802 with generating, by a system comprising at least one processor, precoded data for transmission, via multiple transmit antenna elements, using a precoding matrix corresponding to different transmission layers. A first transmission phase difference between a first antenna element and a second antenna element of the multiple transmit antenna elements comprises a first polarization. A second transmission phase difference between a third antenna element and a fourth antenna element of the multiple transmit antenna elements comprises a second polarization. Further, a transmission phase difference between the first polarization and the second polarization is a 180 degree phase difference or about a 180 degree phase difference. The computer-implemented method 800 continues, at 804, with transmitting, by the system via the multiple transmit antenna elements, the precoded data to a user equipment.

According to some implementations, the precoding matrix comprises a group of weight factors comprising a first weight factor, a second weight factor, a third weight factor, and a fourth weight factor. In accordance with these implementations, the computer-implemented method 800 includes assigning, by the system, a first value to the first weight factor, the second weight factor, and the third weight factor. The computer-implemented method 800 also includes assigning, by the system, a second value to the fourth weight factor. In an example, the first value is a positive value and the second value is a negative value. For example, the first value is 1 and the second value is −1. In another example, the first value is −1 and the second value is 1.

In accordance with some implementations, the first antenna element, the second antenna element, the third antenna element, and the fourth antenna element are located in a same radome (e.g., an enclosure). According to some implementations, the first antenna element and the second antenna element are located in a first radome and the third antenna element and the fourth antenna element are located in a second radome, different than the first radome.

Accordingly, as discussed herein, provided is a precoding design principle that provides an omni-directional power emission pattern, which can be made out of a 4 transceiver X-pol antenna. The disclosed embodiments can be utilized with directional antennas and the resulting power emission pattern is the product of the effective omni-pattern and the antennas directional pattern. Further, the principle of a 180 degree, or around a 180 degree, phase difference can be used for any other complex 4TX codebook design.

It should be noted that terms such as “real-time,” “near real-time,” “dynamically,” “instantaneous,” “continuously,” and the like can refer to data which is collected and processed at an order without perceivable delay for a given context, the timeliness of data or information that has been delayed only by the time required for electronic communication, actual or near actual time during which a process or event occur, and temporally present conditions as measured by real-time software, real-time systems, and/or high-performance computing systems. Real-time software and/or performance can be employed via synchronous or non-synchronous programming languages, real-time operating systems, and real-time networks, each of which provide frameworks on which to build a real-time software application. A real-time system may be one where its application can be considered (within context) to be a main priority. In a real-time process, the analyzed (input) and generated (output) samples can be processed (or generated) continuously at the same time (or near the same time) it takes to input and output the same set of samples independent of any processing delay.

Methods that can be implemented in accordance with the disclosed subject matter will be better appreciated with reference to the flow charts provided herein. While, for purposes of simplicity of explanation, the methods are shown and described as a series of flows and/or blocks, it is to be understood and appreciated that the disclosed aspects are not limited by the number or order of flows and/or blocks, as some flows and/or blocks can occur in different orders and/or at substantially the same time with other blocks from what is depicted and described herein. Moreover, not all illustrated flows and/or blocks are required to implement the disclosed methods. It is to be appreciated that the functionality associated with the flows and/or blocks can be implemented by software, hardware, a combination thereof, or any other suitable means (e.g., device, system, process, component, and so forth). Additionally, it should be further appreciated that the disclosed methods are capable of being stored on an article of manufacture to facilitate transporting and transferring such methods to various devices. Those skilled in the art will understand and appreciate that the methods could alternatively be represented as a series of interrelated states or events, such as in a state diagram.

Aspects of systems, devices, apparatuses, and/or processes explained in this disclosure can constitute machine-executable component(s) embodied within machine(s) (e.g., embodied in one or more computer readable mediums (or media) associated with one or more machines). Such component(s), when executed by the one or more machines (e.g., computer(s), computing device(s), virtual machine(s), and so on) can cause the machine(s) to perform the operations described.

In various embodiments, the system can be any type of component, machine, device, facility, apparatus, and/or instrument that comprises a processor and/or can be capable of effective and/or operative communication with a wired and/or wireless network. Components, machines, apparatuses, devices, facilities, and/or instrumentalities that can comprise the system can include tablet computing devices, handheld devices, server class computing machines and/or databases, laptop computers, notebook computers, desktop computers, cell phones, smart phones, consumer appliances and/or instrumentation, industrial and/or commercial devices, hand-held devices, digital assistants, multimedia Internet enabled phones, multimedia players, and the like.

As used herein, the term “storage device,” “first storage device,” “second storage device,” “storage cluster nodes,” “storage system,” “data store” and the like (e.g., node device), can include, for example, private or public cloud computing systems for storing data as well as systems for storing data comprising virtual infrastructure and those not comprising virtual infrastructure. The term “I/O request” (or simply “I/O”) can refer to a request to read and/or write data.

The term “cloud” as used herein can refer to a cluster of nodes (e.g., set of network servers), for example, within an object storage system, which are communicatively and/or operatively coupled to one another, and that host a set of applications utilized for servicing user requests. In general, the cloud computing resources can communicate with user devices via most any wired and/or wireless communication network to provide access to services that are based in the cloud and not stored locally (e.g., on the user device). A typical cloud-computing environment can include multiple layers, aggregated together, that interact with one another to provide resources for end-users.

Further, the term “storage device” can refer to any Non-Volatile Memory (NVM) device, including Hard Disk Drives (HDDs), flash devices (e.g., NAND flash devices), and next generation NVM devices, any of which can be accessed locally and/or remotely (e.g., via a Storage Attached Network (SAN)). In some embodiments, the term “storage device” can also refer to a storage array comprising one or more storage devices. In various embodiments, the term “object” refers to an arbitrary-sized collection of user data that can be stored across one or more storage devices and accessed using I/O requests.

Further, a storage cluster can include one or more storage devices. For example, a storage system can include one or more clients in communication with a storage cluster via a network. The network can include various types of communication networks or combinations thereof including, but not limited to, networks using protocols such as Ethernet, Internet Small Computer System Interface (iSCSI), Fibre Channel (FC), and/or wireless protocols. The clients can include user applications, application servers, data management tools, and/or testing systems.

As utilized herein an “entity,” “client,” “user,” and/or “application” can refer to any system or person that can send I/O requests to a storage system. For example, an entity, can be one or more computers, the Internet, one or more systems, one or more commercial enterprises, one or more computers, one or more computer programs, one or more machines, machinery, one or more actors, one or more users, one or more customers, one or more humans, and so forth, hereinafter referred to as an entity or entities depending on the context.

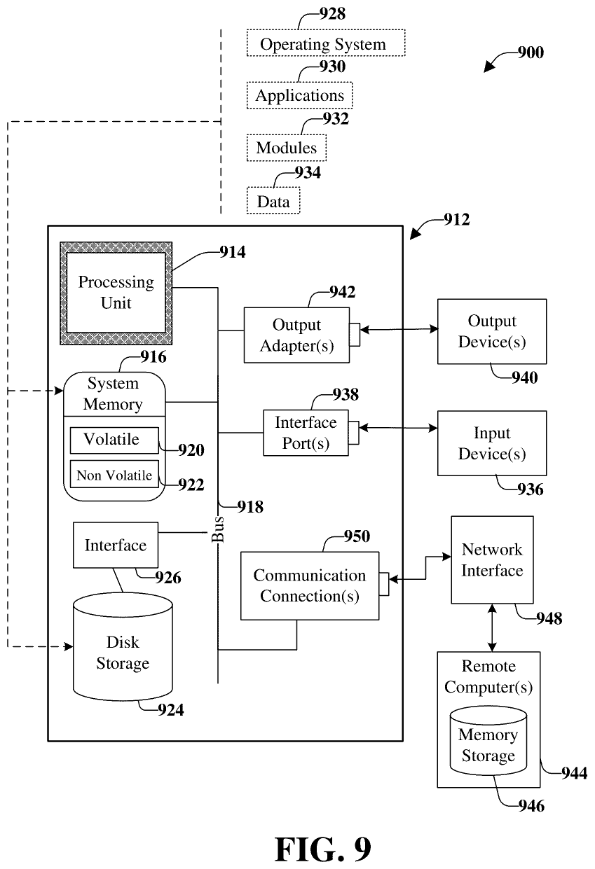

In order to provide a context for the various aspects of the disclosed subject matter, FIG. 9 as well as the following discussion are intended to provide a brief, general description of a suitable environment in which the various aspects of the disclosed subject matter can be implemented.

With reference to FIG. 9, an example environment 910 for implementing various aspects of the aforementioned subject matter comprises a computer 912. The computer 912 comprises a processing unit 914, a system memory 916, and a system bus 918. The system bus 918 couples system components including, but not limited to, the system memory 916 to the processing unit 914. The processing unit 914 can be any of various available processors. Multi-core microprocessors and other multiprocessor architectures can also be employed as the processing unit 914.

The system bus 918 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 comprises volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can comprise read only memory (ROM), programmable ROM (PROM), electrically programmable ROM (EPROM), electrically erasable PROM (EEPROM), or flash memory. Volatile memory 920 comprises random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also comprises removable/non-removable, volatile/non-volatile computer storage media. FIG. 9 illustrates, for example, a disk storage 924. Disk storage 924 comprises, but is not limited to, devices like a magnetic disk drive, floppy disk drive, tape drive, Jaz drive, Zip drive, LS-100 drive, flash memory card, or memory stick. In addition, disk storage 924 can comprise storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 924 to the system bus 918, a removable or non-removable interface is typically used such as interface 926.

According to some implementations, the example environment 910 can include non-transitory machine-readable medium, comprising executable instructions that, when executed by at least one processor of network equipment, facilitate performance of operations. The operations can include generating precoded data for transmission, via multiple transmit antenna elements, using a precoding matrix corresponding to different transmission layers. The operations can also include transmitting, via the multiple transmit antenna elements, the precoded data to a user equipment. The transmitting can include conveying cell level signals with a full power capacity assigned to the network equipment. Additionally or alternatively, the transmitting can include conveying data, via data channels, with a full power capacity assigned to the transmission device.

A first transmission phase difference between a first antenna element and a second antenna element of the multiple transmit antenna elements comprises a first polarization. A second transmission phase difference between a third antenna element and a fourth antenna element of the multiple transmit antenna elements comprises a second polarization. Further, a transmission phase difference between the first polarization and the second polarization is a 180 degree phase difference or substantially a 180 degree phase difference.

In some implementations, the precoding matrix comprises a group of weight factors comprising a first weight factor, a second weight factor, a third weight factor, and a fourth weight factor. Further to these implementations, the operations can include assigning a first value to the first weight factor, the second weight factor, and the third weight factor. The operations can also include assigning a second value to the fourth weight factor. In an example, the first value is 1 and the second value is −1. However, the disclosed embodiments are not limited to these values and other values can be utilized.

It is to be appreciated that FIG. 9 describes software that acts as an intermediary between users and the basic computer resources described in suitable operating environment 910. Such software comprises an operating system 928. Operating system 928, which can be stored on disk storage 924, acts to control and allocate resources of the computer 912. System applications 930 take advantage of the management of resources by operating system 928 through program modules 932 and program data 934 stored either in system memory 916 or on disk storage 924. It is to be appreciated that one or more embodiments of the subject disclosure can be implemented with various operating systems or combinations of operating systems.

A user enters commands or information into the computer 912 through input device(s) 936. Input devices 936 comprise, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 comprise, for example, a serial port, a parallel port, a game port, and a universal serial bus (USB). Output device(s) 940 use some of the same type of ports as input device(s) 936. Thus, for example, a USB port can be used to provide input to computer 912, and to output information from computer 912 to an output device 940. Output adapters 942 are provided to illustrate that there are some output devices 940 like monitors, speakers, and printers, among other output devices 940, which require special adapters. The output adapters 942 comprise, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically comprises many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies comprise Fiber Distributed Data Interface (FDDI), Copper Distributed Data Interface (CDDI), Ethernet/IEEE 802.3, Token Ring/IEEE 802.5, and the like. WAN technologies comprise, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the system bus 918. While communication connection 950 is shown for illustrative clarity inside computer 912, it can also be external to computer 912. The hardware/software necessary for connection to the network interface 948 comprises, for exemplary purposes only, internal, and external technologies such as, modems including regular telephone grade modems, cable modems and DSL modems, ISDN adapters, and Ethernet cards.

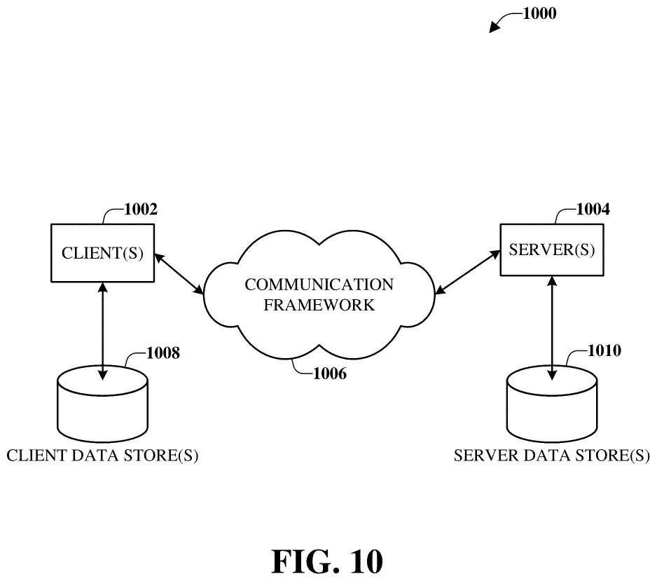

FIG. 10 is a schematic block diagram of a sample computing environment 1000 with which the disclosed subject matter can interact. The sample computing environment 1000 includes one or more client(s) 1002. The client(s) 1002 can be hardware and/or software (e.g., threads, processes, computing devices). The sample computing environment 1000 also includes one or more server(s) 1004. The server(s) 1004 can also be hardware and/or software (e.g., threads, processes, computing devices). The servers 1004 can house threads to perform transformations by employing one or more embodiments as described herein, for example. One possible communication between a client 1002 and servers 1004 can be in the form of a data packet adapted to be transmitted between two or more computer processes. The sample computing environment 1000 includes a communication framework 1006 that can be employed to facilitate communications between the client(s) 1002 and the server(s) 1004. The client(s) 1002 are operably connected to one or more client data store(s) 1008 that can be employed to store information local to the client(s) 1002. Similarly, the server(s) 1004 are operably connected to one or more server data store(s) 1010 that can be employed to store information local to the servers 1004.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

As used in this disclosure, in some embodiments, the terms “component,” “system,” “interface,” “manager,” and the like are intended to refer to, or comprise, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. Yet another example, a component can be an apparatus that provides specific functionality through electronic components without mechanical parts, the electronic components can comprise a processor therein to execute software or firmware that confer(s), at least in part, the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable storage media can comprise, but are not limited to, random access memory (RAM), read only memory (ROM), electrically erasable programmable read only memory (EEPROM), flash memory or other memory technology, solid state drive (SSD) or other solid-state storage technology, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments.

Disclosed embodiments and/or aspects should neither be presumed to be exclusive of other disclosed embodiments and/or aspects, nor should a device and/or structure be presumed to be exclusive to its depicted element in an example embodiment or embodiments of this disclosure, unless where clear from context to the contrary. The scope of the disclosure is generally intended to encompass modifications of depicted embodiments with additions from other depicted embodiments, where suitable, interoperability among or between depicted embodiments, where suitable, as well as addition of a component(s) from one embodiment(s) within another or subtraction of a component(s) from any depicted embodiment, where suitable, aggregation of elements (or embodiments) into a single device achieving aggregate functionality, where suitable, or distribution of functionality of a single device into multiple device, where suitable. In addition, incorporation, combination or modification of devices or elements (e.g., components) depicted herein or modified as stated above with devices, structures, or subsets thereof not explicitly depicted herein but known in the art or made evident to one with ordinary skill in the art through the context disclosed herein are also considered within the scope of the present disclosure.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGs., where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
generating, by a system comprising at least one processor, precoded data for transmission, via multiple transmit antenna elements, using a precoding matrix corresponding to different transmission layers, wherein a first transmission phase difference between a first antenna element and a second antenna element of the multiple transmit antenna elements comprises a first polarization, wherein a second transmission phase difference between a third antenna element and a fourth antenna element of the multiple transmit antenna elements comprises a second polarization, and wherein a transmission phase difference between the first polarization and the second polarization is a 180 degree phase difference or about a 180 degree phase difference; and
transmitting, by the system via the multiple transmit antenna elements, the precoded data to a user equipment.

2. The method of claim 1, wherein the precoding matrix comprises a group of weight factors comprising a first weight factor, a second weight factor, a third weight factor, and a fourth weight factor, and wherein the method further comprises:
assigning, by the system, a first value to the first weight factor, the second weight factor, and the third weight factor; and
assigning, by the system, a second value to the fourth weight factor.

3. The method of claim 2, wherein the first value is a positive value, and wherein the second value is a negative value.

4. The method of claim 2, wherein the first value is 1, and wherein the second value is −1.

5. The method of claim 2, wherein the first value is −1, and wherein the second value is 1.

6. The method of claim 1, wherein the first antenna element, the second antenna element the third antenna element, and the fourth antenna element are located in a same radome.

7. The method of claim 1, wherein the first antenna element and the second antenna element are located in a first radome, and wherein the third antenna element and the fourth antenna element are located in a second radome, different than the first radome.

8. Network equipment, comprising:
a transmission device comprising a four-transceiver cell configuration, comprising:
a first antenna pair comprising:
a first antenna, and
a second antenna,
a second antenna pair comprising
a third antenna, and
a fourth antenna; and
a precoder that generates precoded data using a precoding matrix that comprises a first signal phase assigned to the first antenna, a second signal phase assigned to the second antenna, a third signal phase assigned to the third antenna, and a fourth signal phase assigned to the fourth antenna, wherein the fourth signal phase is a 180 degree signal phase difference from the first signal phase, the second signal phase, and the third signal phase; and
a transmitter that transmits the precoded data according to the precoding matrix.

9. The network equipment of claim 8, wherein the first signal phase is zero degrees, the second signal phase is α degrees, the third signal phase is β degrees, and the fourth signal phase is of β plus α and around 180 degrees.

10. The network equipment of claim 8, wherein a group of weight factors assigned to the comprises 1, 1, 1, and −1, or any combination thereof.

11. The network equipment of claim 8, wherein a group of weight factors assigned to the comprises −1, −1, −1, and 1, or any combination thereof.

12. The network equipment of claim 8, wherein the first antenna pair and the second antenna pair are located in a same structural enclosure.

13. The network equipment of claim 8, wherein the first antenna pair is located in a first structural enclosure, and wherein the second antenna pair is located in a second structural enclosure different than the first structural enclosure.

14. The network equipment of claim 8, wherein a power emission pattern of the transmitter is omnidirectional.

15. The network equipment of claim 8, wherein the transmitter conveys cell level signals with a full power capacity assigned to the transmission device.

16. The network equipment of claim 8, wherein the transmitter conveys data, via data channels, with a full power capacity assigned to the transmission device.

17. A non-transitory machine-readable medium, comprising executable instructions that, when executed by at least one processor of network equipment, facilitate performance of operations, the operations comprising:
generating precoded data for transmission, via multiple transmit antenna elements, using a precoding matrix corresponding to different transmission layers, wherein a first transmission phase difference between a first antenna element and a second antenna element of the multiple transmit antenna elements comprises a first polarization, wherein a second transmission phase difference between a third antenna element and a fourth antenna element of the multiple transmit antenna elements comprises a second polarization, and wherein a transmission phase difference between the first polarization and the second polarization is a 180 degree phase difference or substantially a 180 degree phase difference; and
transmitting, via the multiple transmit antenna elements, the precoded data to a user equipment.

18. The non-transitory machine-readable medium of claim 17, wherein the precoding matrix comprises a group of weight factors comprising a first weight factor, a second weight factor, a third weight factor, and a fourth weight factor, and wherein the operations further comprise:
assigning a first value to the first weight factor, the second weight factor, and the third weight factor; and
assigning a second value to the fourth weight factor.

19. The non-transitory machine-readable medium of claim 18, wherein the first value is 1, and wherein the second value is −1.

20. The non-transitory machine-readable medium of claim 17, wherein the transmitting comprises conveying cell level signals with a full power capacity assigned to the network equipment.
